(19) United States
(12) Patent Application Publication
(10) Pub. No.: US 2013/0098861 A1
(43) Pub. Date: Apr. 25, 2013

(54) FLUID CONTAINMENT SYTEM WITH NIPPLE ADAPTER

(71) Applicant: NEOMED, INC., Woodstock, GA (US)

(72) Inventors: Anthony C. LAIR, Alpharetta, GA (US); Aaron N. INGRAM, Canton, GA (US); Mark Martin COSTELLO, Co. Mayo (IE); Tony DOHERTY, Co. Mayo (IE)

(73) Assignee: NEOMED, INC., Woodstock, GA (US)

(21) Appl. No.: 13/655,757

(22) Filed: Oct. 19, 2012

Related U.S. Application Data
(60) Provisional application No. 61/548,970, filed on Oct. 19, 2011.

(51) Int. Cl. A61J 11/04; A61J 9/00; A61J 11/00

(52) U.S. Cl. CPC A61J 11/04; A61J 11/002; A61J 9/00
USPC 215/11.1; 215/11.4

(57) ABSTRACT

A container attachment for selectively permitting and prohibiting the flow of fluid from a contained volume. The container attachment has an attachment housing configured for attachment to the container. The container attachment also has a nipple and a substantially rigid port access assembly securable to the housing. A one-way flow control mechanism is retained interiorly of the nipple to prevent backflow of fluid into the container.

### CROSS-REFERENCE TO RELATED APPLICATION

This application claims the priority benefit of U.S. Provisional Patent Application Ser. No. 61/548,970 filed on Oct. 19, 2011, which is hereby incorporated by reference herein. U.S. Non-Provisional Patent Application Ser. No. 13/191,721 filed Jul. 27, 2011 and U.S. Provisional Patent Application Ser. No. 61/513,004 filed Jul. 29, 2011 are also hereby incorporated by reference herein.

### TECHNICAL FIELD

The present invention relates generally to the field of containment and dispensing of fluids, and more particularly to a containment and dispensing system for biological fluids, such as breast milk and/or dietary or medicinal materials, the system including a nipple adapter for fluid delivery.

### BACKGROUND

Maintaining aseptic integrity is of great importance in many fluid containment and dispensing applications. For example, in the delivery of breast milk or formula to premature infants who are unable to feed regularly, freshness and prevention of contamination are critical. The delivery of enteral fluids is often controlled by regulations and medical standards of practice.

In addition to proper collection and dispensing of biological fluids such as breast milk or formula, it is also desirable to provide for the containment, mixing and delivery of pharmaceutical or nutritional supplements. Various consumer and/or professional applications would benefit from improved systems and methods for fluid containment and delivery.

For delivery of breast milk, formula or other fluids to infants and neonates, it is often desirable to allow delivery via an outlet that simulates natural breast feeding through a nipple. Typical nipple fittings for feeding bottles and the like, however, are generally not adapted to use in connection with aseptic containment systems, and may not provide aseptic sealing of a container's contents.

It is to the provision of improved systems and methods for fluid containment and delivery meeting these and other needs that the present invention is primarily directed.

### SUMMARY

In example embodiments, the present invention provides improved systems and methods for fluid containment and delivery. Example embodiments include a container attachment for fluid delivery from a contained volume. The container attachment includes a nipple having a delivery port for allowing fluid communication therethrough, a one-way flow control mechanism to prevent backflow of fluid from the nipple into the aseptic contained volume of the container, and a coupling for removable attachment to the container.

In one aspect, the present invention relates to a fluid containment and dispensing system. The system preferably includes a container enclosing a contained volume and having a sealed fluid transfer port for allowing passage of fluid therethrough in an open configuration and for preventing passage of fluid therethrough in a closed configuration. The system preferably also includes a container attachment having a coupling for attachment to the container, a nipple for delivering fluid during feeding, and a port assembly for cooperative engagement with the fluid transfer port of the container to open the port assembly when the coupling of the container attachment is attached to the container.

In another aspect, the invention relates to a container attachment for dispensing fluid from a container. The container attachment preferably includes a coupling for attachment to the container; a lead-in portion for opening a fluid port of the container upon attachment of the coupling to the container; a fluid dispensing nipple for feeding the fluid; and a one-way flow control mechanism for allowing discharge of material from the contained volume and resisting backflow of material into the contained volume.

In still another aspect, the invention relates to a method of selectively allowing and preventing flow of a fluid from a container. The method preferably includes the steps of coupling a container attachment to the container, accessing a contained volume of the container through a port assembly of the container attachment through a normally closed sealing port of the container upon coupling of the container attachment to the container, and dispensing fluid from the container through a nipple element of the container attachment in fluid communication with the port assembly.

In still another aspect, the invention relates to a container attachment for dispensing fluid from a container comprising a flexible seal. The container attachment includes a port assembly comprising a base and an elongated channel defined within a lead-in spike. The lead-in spike is configured to penetrate the flexible seal and receive the fluid from the container. And, the invention also includes a flexible nipple with a conduit engaged with respect to the port assembly elongated channel. The flexible nipple conduit is configured to receive the fluid from the container.

In still yet another aspect, the invention relates to a container attachment for dispensing fluid from a container comprising a flexible seal that has a sealably-deformable passageway. The container attachment includes a port assembly with an annular spike configured to protrude through the sealably-deformable passageway. And, the container attachment includes a flexible nipple engaged with the port assembly. The flexible nipple includes a conduit to deliver the fluid dispensed from the container.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a side view in partial cross-section of a containment and dispensing system including a nipple adaptor according to an example embodiment of the present invention.

FIG. 2 is another side view of the system of FIG. 1, with a cap or cover portion removed.

FIG. 3 is a side view in partial cross-section of a containment and dispensing system including a nipple attachment, according to another example embodiment of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

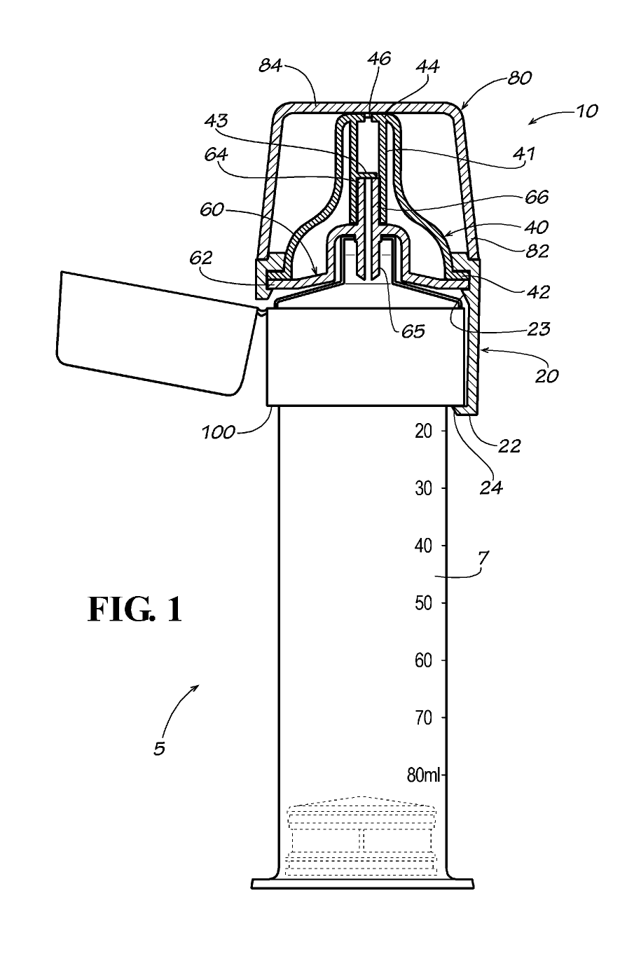

With reference now to the drawing figures, wherein like reference numbers represent corresponding parts throughout the several views, FIG. 1 shows a containment and dispensing system 5 for fluids such as breast milk, formula, medications, or other liquid or fluid contents. This containment and dispensing system 5 can be constructed similarly to the systems described in U.S. Non-Provisional Patent Application Ser. No. 13/191,721 and U.S. Provisional Patent Application Ser. No. 61/513,004, which are incorporated herein by reference. For example, the system includes a container attachment 10 and a sealing head 100 for containing and/or dispensing fluid according to an example form of the invention. The sealing head 100 further includes a discharge port with a seal constructed of flexible material, for example silicon. This flexible seal can extend from an external region of the sealing head port and along the internal walls. The flexible seal can have a pair of access slits self-sealing the sealing head port. The container attachment 10 comprises a coupling 20 for releasable attachment to a container or housing 7, a flexible fluid dispensing nipple 40, a canula or port assembly 60 for accessing the contained volume of the housing 7, and a removable closure/sanitary cap 80.

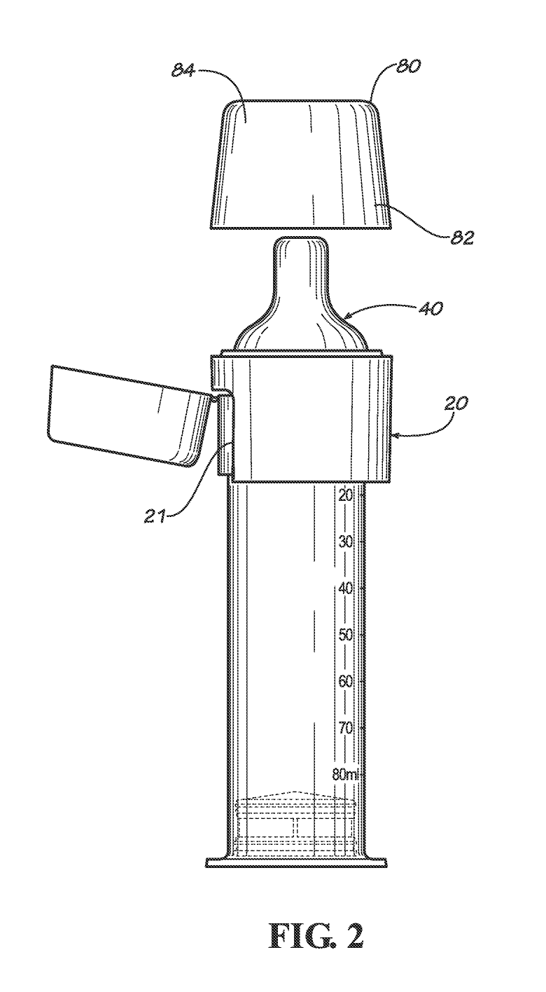

The coupling 20 comprises a generally cylindrical mounting flange or collar 22 having a hook, lip or other engagement means 24 for engaging a cooperating portion of the container 7, for example the cap flange 100 of the container in the depicted embodiment. The cylindrical mounting flange 22 optionally further comprises one or more cutout portions or recesses 21 (see FIG. 2) to fit over a cap hinge and/or other projecting elements of the container 7. An internal flange or lip 23 projects inwardly from the housing 20 to receive and engage cooperating profile elements of the nipple 40 and/or port assembly 60 to retain the elements in an assembled configuration.

The nipple 40 comprises a base flange 42 at a first end, and a cylindrical or conical nozzle 44 having the general contour of a natural nipple and a discharge aperture 46 at its second end. A cylindrical sleeve or channel 41 surrounds aperture 46 and extends internally partially through the nipple. A one-way flow control mechanism or valve is provided within the cylindrical sleeve 41, for example in the form of a transversely oriented flexible flap or panel 43. The nipple 40 is preferably formed of a food-contact grade flexible material such as latex or elastomers (i.e. silicones, PVC, polyurethane, etc.). The nipple 40, sleeve 41 and flap 43 can be formed with a unitary construction.

The port assembly 60 comprises a substantially circumferential base flange 62 at a first end and a cylindrical tube 66 with an annular distal face surrounding an orifice 64 at its second end. The proximal end of the cylindrical tube 66 comprises a tapered lead-in portion or spike 65 for extending through the flexible sealed discharge port of the container 7 to allow fluid communication with the contained volume of the container. The tapered lead-in portion or spike 65 can have an annular rim at its free end and has sufficient rigidity to force through the flexible seal in the sealing head 100. The distal end 64 of the tube 66 of the port assembly preferably fits within the cylindrical sleeve 41 of the nipple and is removably engaged therein with an interference or friction fit. The port assembly 60 can be constructed of rigid and durable material, for example plastic.

The annular distal face surrounding the orifice 64 at the second end of the tube 66 abuts against or is positioned in close proximity with the transversely oriented flexible flap or panel or valve 43 of the nipple 40. In this manner, the flap 43 is pulled out of contact with the annular distal face surrounding the orifice 64 by suction drawn through the aperture 46 of the nipple during feeding, to allow fluid to flow from the contained volume of the container 7 through the nipple; but the flap returns or closes under its own resilience into contact with the annular distal face when suction is released, to prevent backflow into the contained volume which could compromise aseptic storage within the contained volume.

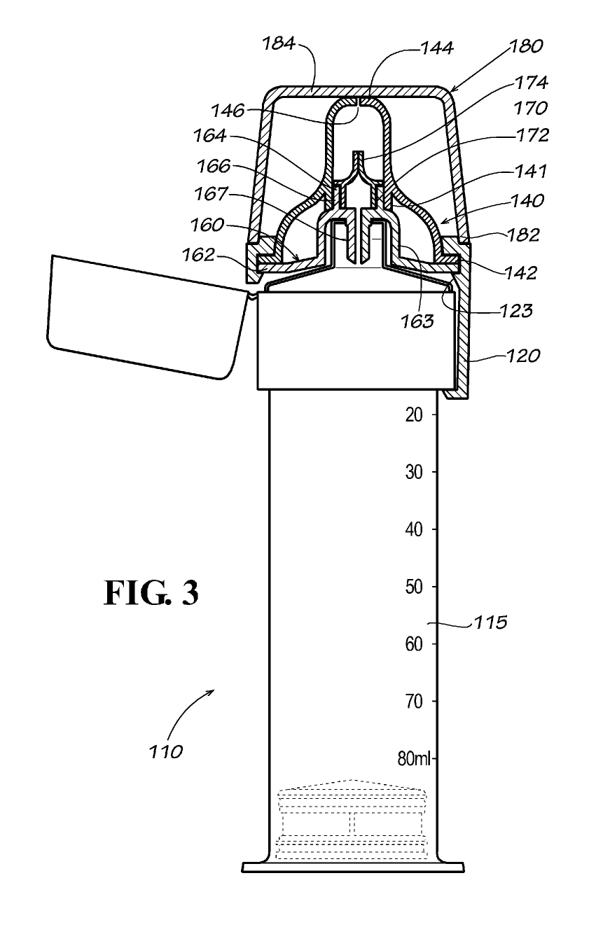

The closure cap 80 is removably mountable to the housing 20 and comprises a circumferential rim or collar 82 extending from a circular lid panel 84. The closure cap is thereby movable between a closed configuration (see FIGS. 1, 3) covering the nipple 40, and an open configuration (see FIG. 2) allowing access to the nipple 40. A snap fitting is preferably provided between the rim of the cap and the coupling collar 22 to releasably retain the cap in the closed configuration.

FIG. 3 shows an alternative embodiment of a containment system 110, substantially similar to the above-described system 10 with differences as noted. The alternative embodiment flexible nipple 140 comprises a base flange 142 at a first end for attachment to the coupling collar 120, and a second end 144 having an aperture 146 and the general contour of a natural nipple. A cylindrical sealing collar 141 extends internally and coaxially through the nipple with its free end projecting towards the base flange 142. The alternative embodiment port assembly 160 has a base flange 162 shown to be secured with respect to the coupling collar 120, and a cylindrical connection hub 163 projecting from the center of the base flange. A cylindrical tube or collar 166 with a distal end 164 extends from a first face of the connection hub 163, and a tapered lead-in portion or spike 167 extends from a second face of the connection hub 163 opposite tube or collar 166 for extending through the sealed discharge port of the container 115, similarly to the spike 65 described in FIG. 1. The sealing collar 141 of the nipple 140 sealingly engages about the circumference of the tube or collar 166.

A one-way valve 170 is engaged as a check valve within the interior of cylindrical tube or collar 166 of the port assembly 160. A valve engagement collar 172 is sealingly engaged within the tube or collar 166 of the connection hub 163 with a tight friction or interference fit, and a confronting pair of resilient flaps or duck-bill sealing assembly 174 extends axially therefrom. The one-way valve 170 can be sealingly engaged within the nipple collar 141. Alternatively, the one-way valve 170 and the nipple 140 can form a single unitary construction. In this manner, flow is allowed through the valve 170 from the contained volume of the container 115 to the discharge 146 of the nipple 140 as suction is drawn on the nipple during feeding; but flow is prevented in the reverse direction back into the contained volume, to prevent potential contamination. The one-way valve 170 can be constructed of resiliently-flexible material such that in the absence of flow through the sealing assembly 174 the sealing assembly returns to a sealed relaxed state.

In an example method of use, breast milk, formula or other fluid is stored in the contained volume of an aseptic containment and dispensing system. A hinged cap or closure is opened to expose a sealed fluid transfer port of the container. A container attachment is coupled to the container, for example by engagement of a coupling collar onto a cap flange of the container. Coupling the container attachment to the container inserts a lead-in portion of the container attachment into the sealed fluid transfer port of the container, thereby allowing fluid communication from the container through the container attachment. Suction applied to a nipple portion of the container attachment draws fluid from the container and dispenses the fluid for feeding through the nipple. A one-way flow restrictor prevents fluid from reentering the container. If the container comprises a variable volume container with a movable plunger, suction applied as fluid is withdrawn from the container draws the plunger through the container. Accordingly, the movable plunger and one-way flow restrictor work in tandem with one another and prevent the contained volume from becoming depressurized.

While the invention has been described with reference to preferred and example embodiments, it will be understood by those skilled in the art that a variety of modifications, additions and deletions are within the scope of the invention, as defined by the following claims.

What is claimed is:

1. A fluid containment and dispensing system comprising:
a container enclosing a contained volume and having a sealed fluid transfer port for allowing passage of fluid therethrough in an open configuration and for preventing passage of fluid therethrough in a closed configuration; and
a container attachment comprising a coupling for attachment to the container, a nipple for delivering fluid during feeding, and a port assembly for cooperative engagement with the fluid transfer port of the container to open the port assembly when the coupling of the container attachment is attached to the container.

2. The fluid containment and dispensing system of claim 1, wherein the port assembly comprises a spike for insertion into the fluid transfer port upon coupling the container attachment to the container.

3. The fluid containment and dispensing system of claim 1, wherein the sealed fluid transfer port comprises resiliently-flexible material and at least one sealably-deformable access channel.

4. The fluid containment and dispensing system of claim 1, wherein the container attachment further comprises a one-way flow controller for allowing discharge of fluid from the container through the nipple and preventing backflow into the container.

5. The fluid containment and dispensing system of claim 1, wherein the container comprises a variable volume container having a plunger movably mounted therein to accommodate the contained volume to a variable quantity of fluid contained therein.

6. A container attachment for dispensing fluid from a container comprising a fluid port, the container attachment comprising:
a coupling for attachment to the container;
a lead-in portion for opening the fluid port of the container upon attachment of the coupling to the container;
a fluid dispensing nipple for feeding the fluid; and
a one-way flow control mechanism for allowing discharge of material from the contained volume and resisting backflow of material into the contained volume.

7. The container attachment of claim 6, wherein the lead-in portion comprises a tapered spike.

8. The container attachment of claim 6, wherein the lead-in portion is rigid.

9. The container attachment of claim 6, wherein the lead-in portion comprises an annular distal edge.

10. The container attachment of claim 6, wherein the lead-in portion comprises an interior channel for dispensing the fluid from the container fluid port.

11. A container attachment for dispensing fluid from a container comprising a flexible seal, the container attachment comprising:
a port assembly comprising a base and an elongated channel defined within a lead-in spike, the lead-in spike configured to penetrate the flexible seal and receive the fluid from the container; and
a flexible nipple comprising a conduit engaged with respect to the port assembly elongated channel, the flexible nipple conduit configured to receive the fluid from the container.

12. The container attachment of claim 11, wherein the flexible nipple comprises a unidirectional flow-control valve configured to prevent fluid from entering the container.

13. The container attachment of claim 12, wherein the unidirectional flow-control valve is configured to prevent fluid from entering the port assembly elongated channel.

14. The container attachment of claim 12, wherein the unidirectional flow-control valve is supported by the flexible nipple conduit.

15. The container attachment of claim 11, wherein the port assembly comprises a unitary structure.

16. The container of claim 11, wherein the lead-in spike comprises a tapered distal end with an annular rim.

17. A container attachment for dispensing fluid from a container comprising a flexible seal that has a sealably-deformable passageway, the container attachment comprising:
a port assembly comprising an annular spike configured to protrude through the sealably-deformable passageway; and
a flexible nipple engaged with the port assembly, the flexible nipple comprising a conduit to deliver the fluid dispensed from the container.

18. The container attachment of claim 17, wherein the port assembly comprises a tube engaged with the flexible nipple conduit.

19. A method of selectively allowing and preventing flow of a fluid from a container, the method comprising coupling a container attachment to the container, accessing a contained volume of the container through a port assembly of the container attachment through a normally closed sealing port of the container upon coupling of the container attachment to the container, and dispensing fluid from the container through a nipple element of the container attachment in fluid communication with the port assembly.

20. The method of claim 19, further comprising preventing backflow of fluid through the port assembly back into the container.
